(19) United States
(12) Patent Application Publication
(10) Pub. No.: US 2019/0110165 A1
(43) Pub. Date: Apr. 11, 2019

(54) Mobile Location Information System and Method

(71) Applicant: LeeRand Michelle Green, Houston, TX (US)

(72) Inventor: LeeRand Michelle Green, Houston, TX (US)

(21) Appl. No.: 16/155,462

(22) Filed: Oct. 9, 2018

Related U.S. Application Data
(60) Provisional application No. 62/570,403, filed on Oct. 10, 2017.

(51) Int. Cl. H04W 4/029

(52) U.S. Cl. CPC H04W 4/029

(57) ABSTRACT

A mobile location information system including a server, a database, and a mobile electronic device. The database may be operatively coupled to the server and contain information specific to a plurality of geographic locations. The mobile electronic device may include a GPS component and a storage, and may operate an application program installed on the storage of the mobile electronic device. The application program may include program instructions to transmit a selected location to the server, receive a map of the selected location from the server, and receive information specific to one geographic location of the plurality of geographic locations from the database via the server. The one geographic location may be identical to the selected location, and the information specific to the one geographic location may include at least one of language spoken, currency used, government type, common spoken phrases, and cultural practices.

### CROSS-REFERENCE TO RELATED APPLICATIONS

This application claims benefit of U.S. Prov. Appl. No. 62/570,403, filed on Oct. 10, 2017, the contents of which are hereby incorporated by reference to the extent not inconsistent with the present disclosure.

### BACKGROUND

Traveling to a new destination, such as a foreign country, can present a number of unique challenges to a traveler, particularly the first time the traveler plans for and embarks on such a trip. For example, the culture and customs of a particular foreign country may not be familiar to the traveler. Accordingly, the traveler may be unaware of particular actions or expressions that may be offensive to residents of the foreign country. Additionally, a language barrier may exist, preventing the traveler from interacting with the residents. Further, the traveler may not be familiar with other aspects of the foreign country, such as the currency used or the location of local attractions.

What is needed, then, is a system and method for providing information specific to a particular foreign country to a traveler before or during a trip thereto, in order to provide a facile and enjoyable experience in the foreign country.

### SUMMARY

Embodiments of the disclosure may provide a mobile location information system. The mobile location information system may include a server, a database, and a mobile electronic device. The database may be operatively coupled to the server and contain information specific to a plurality of geographic locations. The mobile electronic device may include a GPS component and a storage, and may operate an application program installed on the storage of the mobile electronic device. The application program may include program instructions to transmit a selected location to the server, receive a map of the selected location from the server, and receive information specific to one geographic location of the plurality of geographic locations from the database via the server. The one geographic location may be identical to the selected location, and the information specific to the one geographic location may include at least one of language spoken, currency used, government type, common spoken phrases, and cultural practices.

Embodiments of the disclosure may further provide a method for providing location information to a user of a mobile electronic device. The method may include receiving via a server a selected location from the mobile electronic device. The method may also include generating a map of the selected location, and transmitting the map of the selected location from the server to the mobile electronic device. The method may further include searching one or more databases operatively coupled to the server and containing information specific to a plurality of geographic locations. The method may also include retrieving, from the one or more databases, information specific to one of the geographic locations matching the selected location, the information including at least one of language spoken, currency used, government type, common spoken phrases, and cultural practices. The method may further include transmitting the information to the mobile electronic device.

Embodiments of the disclosure may further provide a mobile electronic device. The mobile electronic device may include a display, a processor, a bus system, a storage, and an application program. The storage, in operation, may communicate with the processor over the bus system. The application program may reside on the storage, and when invoked by the processor over the bus system, may include program instructions to transmit a selected location to a server communicatively coupled to the mobile electronic device, receive a map of the selected location from the server, display the map of the selected location on the display, and receive information specific to the selected location from one or more databases operatively coupled to the server. The information specific to the selected location may include at least one of language spoken, currency used, government type, common spoken phrases, and cultural practices.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a schematic of an exemplary mobile location information system, according to one or more embodiments disclosed.

FIG. 2 illustrates selected portions of the hardware and software architecture of a mobile electronic device of the mobile location information system of FIG. 1.

FIG. 3 is a schematic representation of program instructions for the mobile electronic device running an application program, according to one or more embodiments.

FIG. 4 illustrates an exemplary screen shot of a home page of the application program, according to one or more embodiments.

FIG. 5 illustrates an exemplary screen shot of the application program displaying a map of a particular destination of interest, according to one or more embodiments.

FIG. 6 illustrates an exemplary screen shot of the application program displaying a first portion of pertinent information related to the particular destination, according to one or more embodiments.

FIG. 7 illustrates an exemplary screen shot of the application program displaying a second portion of the pertinent information related to the particular destination, according to one or more embodiments.

FIG. 8 is a flowchart depicting a method for providing location information to a user of the mobile electronic device, according to one or more embodiments.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

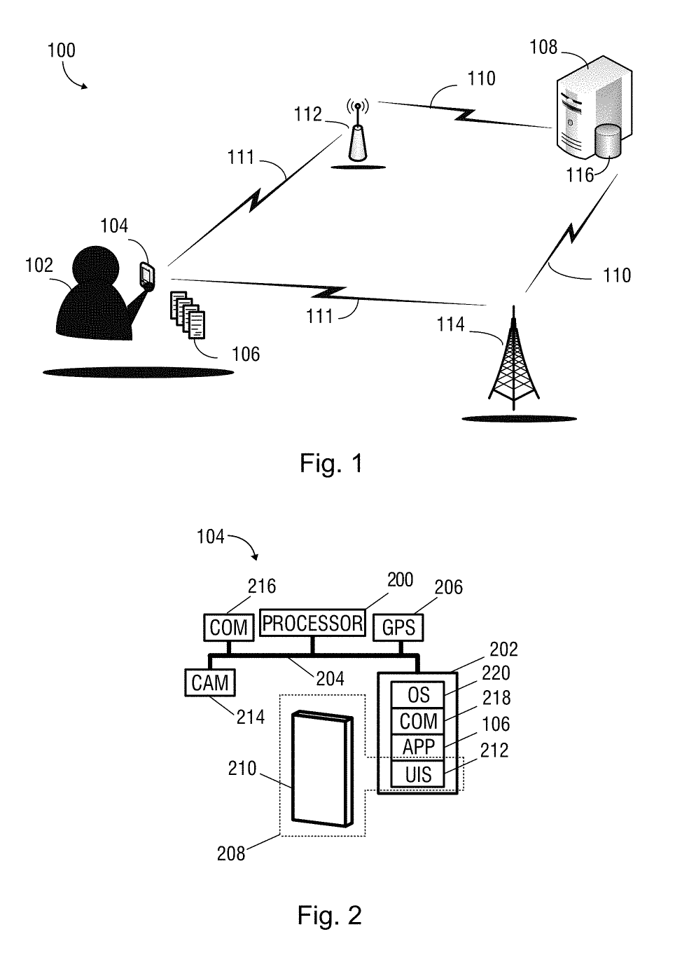

FIG. 1 illustrates a schematic of an exemplary mobile location information system 100, according to one or more embodiments disclosed. The mobile location information system 100 may be configured to provide information related to a particular destination selected by a user 102 thereof. For example, the destination selected may be a foreign country the user 102 is planning to visit or is currently visiting. The information provided may be information useful to a visitor or potential visitor of the destination and may include, but is not limited to, the name of the destination, the spoken language(s) of the destination, useful terms or phrases in such spoken language(s), particular customs and cultural aspects of the indigenous population of the destination, currency accepted, time zone, local tourist attractions, and pictures and comments provided by other users of the mobile location information system 100 related to the destination.

To that end, the mobile location information system 100 may include a mobile electronic device 104 having an application program, or app 106, installed thereon and being communicatively coupled to one or more servers (one shown 108) via a network 110. The network 110 may be a public network, a private network, a wire line network, a wireless network, an optical network, other suitable communications media or a suitable combination of such communications media. The mobile electronic device 104 may access the network 110 via a wired communication link or a wireless communication link 111, such as by Wi Fi (represented by the hot spot 112) or by wireless telephony (represented by the cellular tower 114). In one or more embodiments, the network 110 is the Internet. However, the present disclosure is not limited thereto, and in other embodiments, a peer-to-peer architecture or some hybrid of a peer-to-peer and client/server architecture for a computing system may be employed in lieu of the network 110.

As illustrated in FIG. 1, the mobile electronic device 104 may be communicatively coupled to a remote server 108 and configured to send and receive data to/from the remote server 108 via the network 110. The remote server 108 may be operatively coupled to a data structure, such as a database 116, configured to store data (e.g., user profile, pictures, etc.) related to each user 102 of the app 106. The remote server 108 may be further communicatively coupled to a plurality of third party, private or public servers (not shown). The servers may each be operatively coupled to a respective data structure, e.g., database (not shown). Each of the servers may be configured to transmit respective data including, for example, language(s) of a selected destination, useful terms or phrases in such language(s), particular customs of the indigenous population of the selected destination, currency accepted in the selected destination, time zone of the selected destination, and local tourist attractions located in the selected destination.

A service provider (not shown) may operate the mobile location information system 100 through the remote server 108. In one embodiment, the service provider may do so via an internet website. To gain access to the mobile location information system 100, each user 102 of the mobile location information system 100 may be prompted to create a user profile with the service provider. Preferably, the user profile is created online via the website or the mobile electronic device 104 after downloading the app 106 to the user's mobile electronic device 104, but the user profile may alternatively be created over the phone, in person, in writing, or by any other suitable means of communicating profile information to a representative of the service provider. The user profile may include log in information, such as a user name and password. In addition, the user profile may include personal information (e.g., profile pictures) and travel preferences. Travel preferences may include, by way of example, preferred airlines and hotel chains, frequent destinations, favorite activities/locations at a particular destination, etc.

For present purposes, the mobile electronic device 104 is a handheld electronic device that performs a number of communications, computing, and media functionalities as is well known in the art. In the illustrated embodiment, the mobile electronic device 104 is a smart phone but alternative embodiments may employ other types of mobile electronic devices such as tablets or laptop computers. Although in some embodiments the mobile electronic device 104 may be a fully customized device built solely for the purpose of this disclosure, in other embodiments, the mobile electronic device 104 may be a commercially available mobile electronic device, such as a smart phone, tablet, or laptop customized for use with the system and method disclosed herein via the downloading and installing of the app 106.

Turning now to FIG. 2, selected portions of the hardware and software architecture of the mobile electronic device 104 are shown. The mobile electronic device 104 includes a processor 200 communicating with a storage 202 over an electronic bus system 204. The mobile electronic device 104 further includes a GPS component 206 and a user interface 208 including a display 210 and user interface software (“UIS”) 212 for generating and controlling the user interface 208. The display 210 will typically be a touch screen and the UIS 212 will typically display a virtual keyboard (not shown) when appropriate for user interaction and input. However, some alternative embodiments may instead use a small keypad (not shown) or other peripherals such as stylus (also not shown). In one or more embodiments, the mobile electronic device 104 may further include a camera 214 configured to capture still digital images (e.g., photographs) and dynamic digital images (e.g., video). The mobile electronic device 104 also includes communications hardware 216 and associated software 218 for implementing the communications functionality described above.

The processor 200 will be one of a class of processors designed for use in mobile devices. Mobile devices have unique demands regarding, for example, energy usage and battery life, display, bandwidth, etc. relative to general purpose computers. Accordingly, microchip designers have developed a special class of processors for mobile devices that address these concerns better than do other classes of microprocessors. However, processors for mobile devices are less computationally powerful than processors for general purpose computers.

The storage 202 will typically include random access memory (“RAM”), installed memory, and some removable memory, none of which is separately shown. As with the processor 200, the fact that the storage 202 is part of the mobile electronic device 104 imposes constraints on its design. For example, size and weight restrictions are much more severe than in general purpose computers. Accordingly, the size of the RAM and the installed memory is usually smaller and uses different technologies. For example, removable storage in the mobile electronic device 104 will typically be a SanDisk®, or CompactFlash card, which is a very small, mass storage device that does not require a battery to store data. Removable storage such as is typically used with general purpose computing devices are too large, too heavy, and consume too much energy for practicable use in a mobile electronic device 104. This is also the case for installed memory.

The storage 202 also has an operating system (“OS”) 220 residing thereon that is executed by the processor 200 upon power-up and restart of the mobile electronic device 104. The processor 200 executes the OS 220 to perform the various functionalities of the mobile electronic device 104. For example, the processor 200 invokes and controls the user interface 208 through the OS 220. The OS 220 will typically be one specially designed for mobile devices such as the mobile electronic device 104 rather than one for a general purpose computer.

Note that the processor 200, the storage 202, and the OS 220 are all tailored for use in mobile devices such as the mobile electronic device 104 as mentioned above. This is because of the unique demands regarding, for example, energy usage and battery life, display, bandwidth, etc. that mobile derives experience relative to general purpose computers, also as mentioned above. These constraints work together so that the mobile electronic device 104 performs differently from general purpose computers. Accordingly, the mobile electronic device 104 cannot be said to be a general purpose computer either by design or performance.

In the illustrated embodiment, the mobile electronic device 104 also includes the app 106 residing on the storage 202 that implements certain aspects of the present disclosure. The app 106 may be a factory install or downloaded by the user 102 from, for example, the server 108 over the network 110. Depending on the embodiment, the app 106 may interact with other apps residing in the storage 202 in the course of performing that functionality.

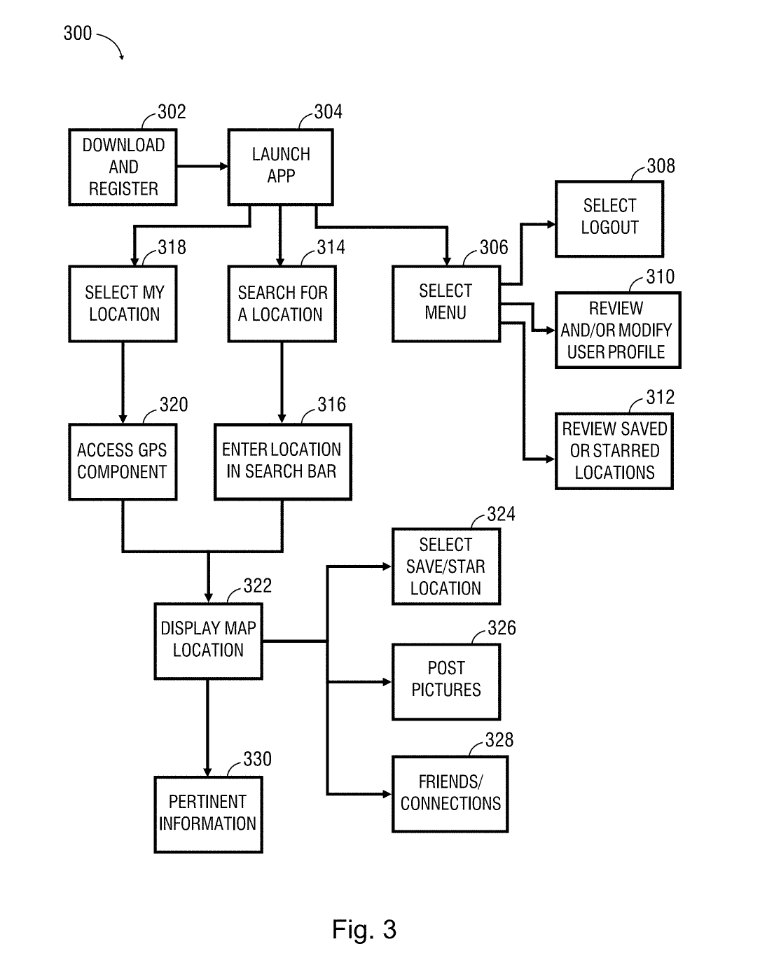

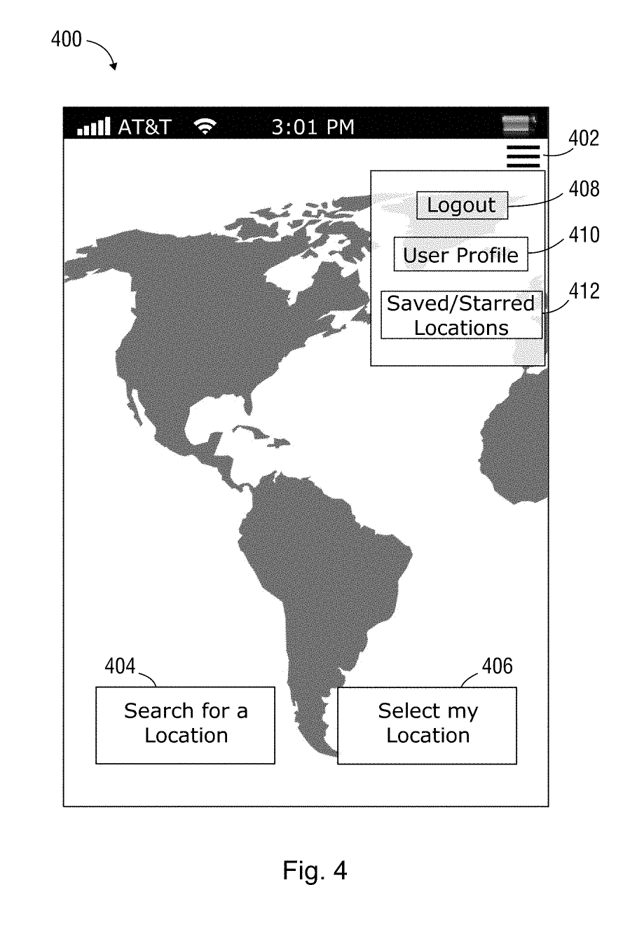

Referring now to FIG. 3 with continued reference to FIGS. 1 and 2, FIG. 3 is a schematic representation of program instructions 300 for the mobile electronic device 104 running the app 106, according to one or more embodiments. As illustrated and discussed above, the user 102 may register to use the mobile location information system 100 by creating a user profile with the service provider online via the internet or by the mobile electronic device 104 after downloading the app 106 on the user's mobile electronic device 104 (block 302). Upon launching the app 106 by the user 102 (generally by selecting (e.g., by touch) an icon (not shown) representative of the app 106 on the user interface 208) and providing the user's log in information, a home page (400, see FIG. 4) of the app 106 will become accessible to the user 102 on the user interface 208 (block 304).

Referring now to FIG. 4 with continued reference to FIGS. 1-3, FIG. 4 illustrates an exemplary screen shot of the home page 400 of the app 106, according to one or more embodiments. As shown in FIG. 4, the home page 400 may include a menu icon 402, a “search for a location” button 404, and a “select my location” button 406. By selecting the menu icon 402, the user 102 may be directed to an expanded list of buttons including, but not limited to, a “log out” button 408, a “user profile” button 410, and a “saved/starred locations” button 412 (block 306). The “log out” button may be selected to exit the app (block 308). The “user profile” button may be selected to review and/or modify portions of the user's profile (block 310). The “saved/starred locations” button may be selected to review saved or starred locations (block 312), which will be discussed in greater detail below.

In the event that the user 102 is planning a trip to a particular destination, the user 102 may select the “search for a location” button 404 on the home page of the app 106 (block 314). By selecting the “search for a location” button 404, the user 102 may be directed to a search bar, at which point the user 102 may be prompted to enter an address, a city, a state, a country, a zip code, or a point of interest in order to identify a particular destination requested by the user (block 316). The app 106 may provide program instructions to the mobile electronic device 104 to transmit the data inputted in the search bar to the remote server 108 having a map generator. In some embodiments, the map generator may be provided in a map server communicatively coupled to the remote server 108. The map generator residing on the remote server 108 or the map server may generate the map. The app 106 may be further configured via program instructions to receive from the remote server 108 (and the map server in some embodiments) the graphical image (i.e., map) of the particular destination requested by the user 102.

In the event that the user 102 is on the trip and at a particular destination, the user 102 may select the “select my location” button 406 on the home page of the app 106 (block 318). By selecting the “select my location” button 406, the app 106 may provide program instructions to the mobile electronic device 104 to access the GPS component 206 thereof to determine the current location of the user 102 via the mobile electronic device 104 (block 320). The GPS component 206 may provide GPS coordinates, which may be transmitted to the map generator residing on the remote server 108 or the map server communicatively coupled thereto. The app 106 may be further configured via program instructions to receive from the remote server 108 (and the map server in some embodiments) the graphical image (i.e., map) of the current location of the user 102.

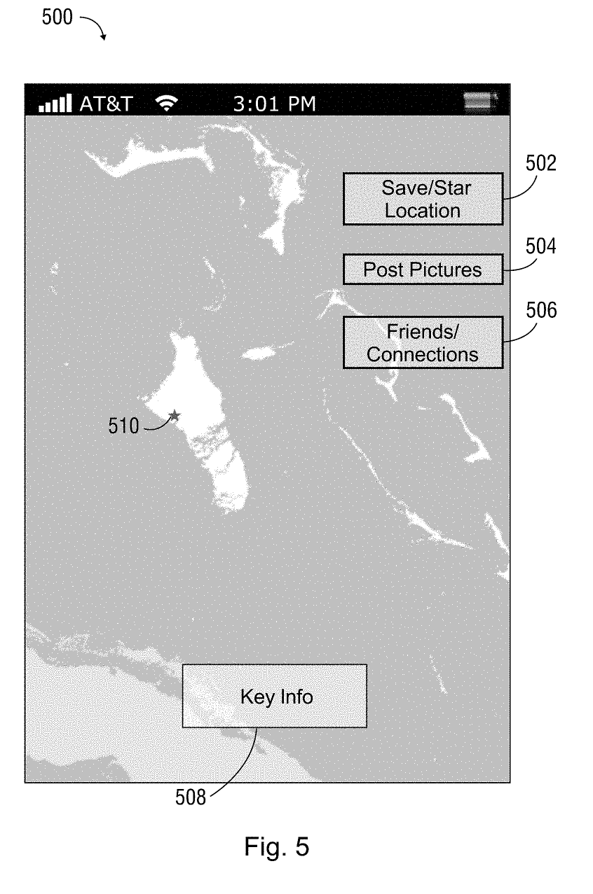

In either the event of block 316 or 320, the user 102 may be provided with a graphical image (i.e., map) of the particular destination of interest (block 322). Referring now to FIG. 5 with continued reference to FIGS. 1-4, FIG. 5 illustrates an exemplary screen shot of the app displaying a map 500 of the particular destination of interest, according to one or more embodiments. As shown in FIG. 5, in addition to the map 500 displayed, a plurality of buttons 502, 504, 506, and 508 may be arranged in an ordered fashion on the display 210. As illustrated, the plurality of buttons 502, 504, 506, and 508 may include a “save/star location” button 502, a “post picture” button 504, and a “connection/friends” button 506 arranged in a side bar orientation on the display 210.

The “save/star location” button 502 may be selected and a drop down menu may appear on the display, where the drop down menu may include a plurality of icons (block 324). In one embodiment, the plurality of icons may be stars; however, the present disclosure is not limited thereto, and the icons may take the form of other shapes. Each icon may be color-coded, with each color being indicative of a different meaning. For example, a red color-coded icon may be indicative of a bucket-list location, a yellow color-coded icon may be indicative of a wish-list location, and a green color-coded icon may be indicative of a planned trip location. The selection of one of the icons may be then associated with the particular destination (shown on the map 500 as 510) and saved in the user's profile. In at least one embodiment, the selected icon may appear at the particular destination on a map (e.g., world map) stored in the user's profile.

The “post pictures” button 504 may be selected and a file folder may appear on the display 210, where the file folder may include a plurality of pictures (block 326). In one embodiment, the plurality of pictures may be located in a file folder stored on the storage 202 of the mobile electronic device 104. The selection of one of the pictures may be then associated with the particular destination (shown on the map 500) and saved in the user's profile. In at least one embodiment, the selected picture may appear as a thumbnail or other representative icon at the particular destination on a map (e.g., world map) stored in the user's profile.

The “connections/friends” button 506 may be selected and a drop down menu or other ordered arrangement may appear on the display 210, where the drop down menu may include a plurality of contacts (block 328). In one embodiment, the plurality of contacts may be names and/or profile pictures of connections or friends associated with the user 102. The names of the connections or friends may appear as links to other users' profiles stored in the database 116 associated with the remote server 108. As provided above, the user profile of each connection or friend may be viewable to the user 102 as authorized by the settings of the respective user profile. For example, the user 102 may allow other connections or friends to only view pictures stored in the user's profile. In another embodiment, the user 102 may authorize other users of the app 106 that are not connections or friends (i.e., the public) to view the user's profile. The app 106 may include program instructions to the mobile electronic device 104 to filter access to the user's profile in a manner selected by the user 102. Accordingly, the user's profile may be configured such that only the user 102 may view the user's profile, one or more connections or friends may view the user's profile, or the public may view the user's profile. In other embodiments, the user's profile may be further configured to allow the user 102 to share a selected portion (e.g., a selected picture or pictures) of the user's profile with one or more connections or friends or the public.

In one or more embodiments, the selected picture or pictures of the user 102 or connections thereof may be visible as thumbnails (not shown) on the map 500 where the selected picture or pictures was taken. Each thumbnail may be outlined in a particular color to indicate if the thumbnail is provided by the user, a connection thereof sharing the picture exclusively with the user 102, or a connection thereof sharing the picture with all other connections.

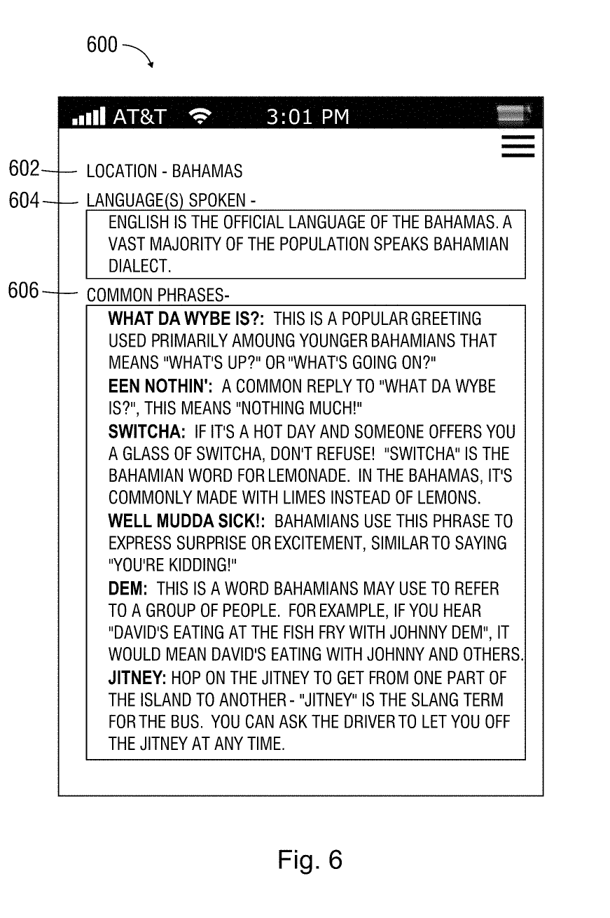

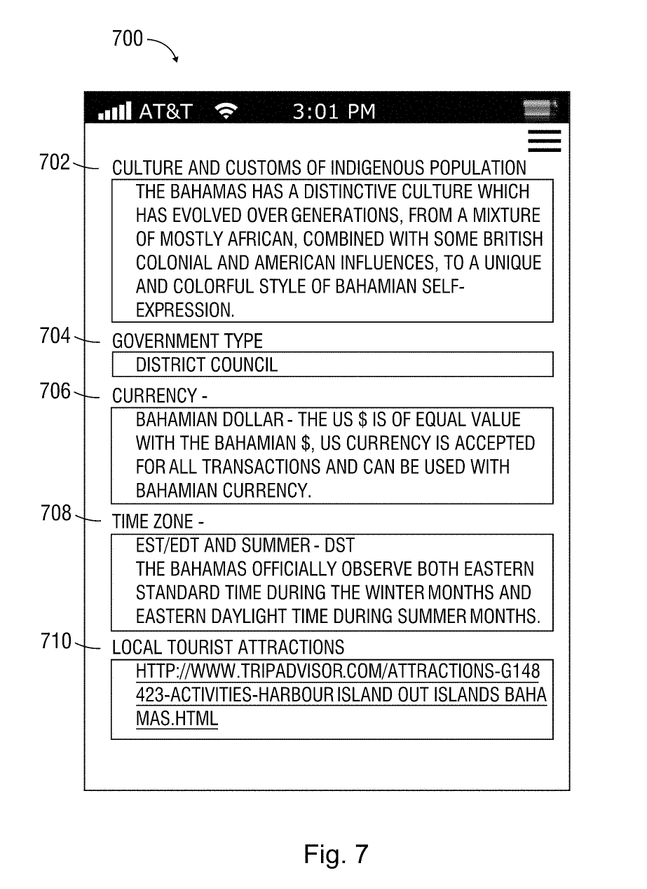

As shown in FIG. 5, the plurality of buttons 502, 504, 506, and 508 may further include a “key info” button 508 displayed separately from the side bar including the “save/star location” button 502, the “post picture” button 504, and the “connection/friends” button 506. The “key info” button 508 may be selected and the user 102 may be directed to pertinent information related to the particular destination (block 330). FIG. 6 illustrates an exemplary screen shot 600 of the app 106 displaying a first portion of the pertinent information related to the particular destination, according to one or more embodiments. FIG. 7 illustrates an exemplary screen shot 700 of the app 106 displaying a second portion of the pertinent information related to the particular destination, according to one or more embodiments. The screen shot 700 of FIG. 7 may be indicative of a continuation of the display 210 after scrolling down from the screen shot 600 displayed in FIG. 6.

Referring now to FIGS. 6 and 7 with continued reference to FIGS. 1-3, the pertinent information as displayed in the exemplary screen shots 600 and 700 in an expanded view may include the location name 602, languages of the location 604, key phrases in the language 606, cultural practices and customs 702, government type 704, currency accepted 706, time zone 708, and local tourist attractions 710. It will be appreciated that the present disclosure is not limited thereto, and other pertinent information may be provided within the scope of the present disclosure. In one or more embodiments, the pertinent information may be displayed as a heading and a text box underneath each heading, where the text box may be displayed after selecting the heading, as shown in FIGS. 6 and 7. Accordingly, although not shown, prior to the selection of any heading, the screen shots for FIGS. 6 and 7 may include only the headings for each of the location name 602, languages of the location 604, key phrases in the language 606, cultural practices and customs 702, government type 704, currency accepted 706, time zone 708, and local tourist attractions 710.

The app 106 may include program instructions to the mobile electronic device 104 to receive from the remote server 108 (and one or more other servers in some embodiments) the pertinent information for the particular destination requested by the user 102. To that end, the remote server 108 may include an information engine (not shown) configured to query one or more other servers for the pertinent information in response to program instructions provided by the app 106. The remote server 108 may retrieve the pertinent information from the one or more other servers via the information engine and transmit the pertinent information to the mobile electronic device 104. Additionally, the app 106 may include program instructions to provide the pertinent information with embedded links, such that the selection of the pertinent information may result in additional information from the remote server 108, and in some embodiments, one or more other servers, to be transmitted to the mobile electronic device 104 for the user 102 to view. For example, the user 102 selecting a link embedded in the local tourist attractions may be provided with a listing of available hotels near the local tourist attraction selected.

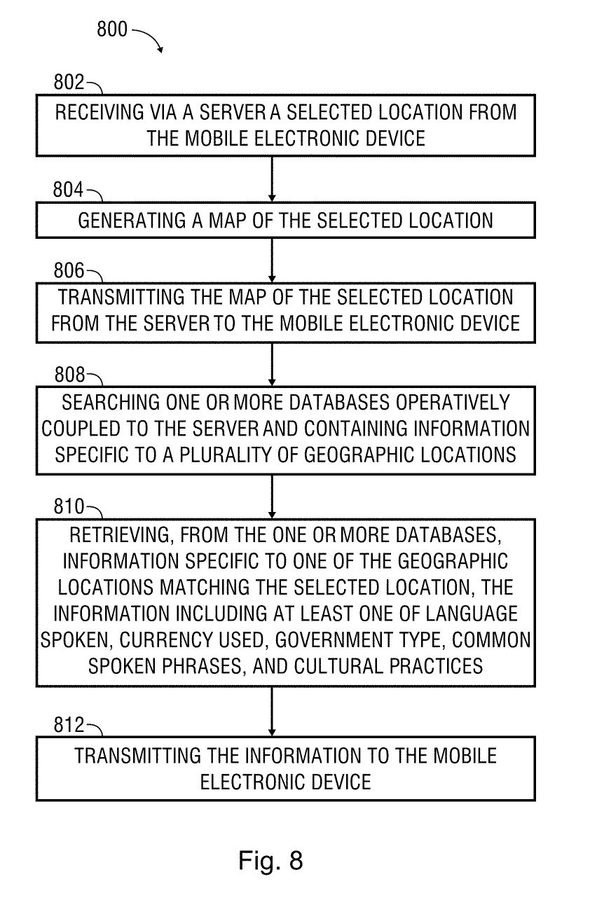

Turning now to FIG. 8, FIG. 8 is a flowchart depicting a method 800 for providing location information to a user of a mobile electronic device, according to one or more embodiments. The method 800 may include receiving via a server a selected location from the mobile electronic device (block 802). The method 800 may also include generating a map of the selected location (block 804), and transmitting the map of the selected location from the server to the mobile electronic device (block 806).

The method 800 may further include searching one or more databases operatively coupled to the server and containing information specific to a plurality of geographic locations (block 808). The method 800 may also include retrieving, from the one or more databases, information specific to one of the geographic locations matching the selected location, the information including at least one of language spoken, currency used, government type, common spoken phrases, and cultural practices (block 810). The method 800 may further include transmitting the information to the mobile electronic device (block 812).

With reference to method 800, in at least one embodiment, the selected location is determined by a GPS component of the mobile electronic device. In another embodiment, the selected location is based on input from the user, the input selected from a group consisting of a country, a zip code, a city, a state, and a point of interest. In one or more embodiments, the information specific to the geographic location matching the selected location may include one or more links configured to retrieve additional information specific to the geographic locations matching the selected location.

In one or more embodiments, the method 800 may also include storing a user profile of the user on the server, and providing access to the user profile to other users based on privacy settings selected by the user. The method 800 may further include associating an icon with the selected location on the map, and storing the map of the selected location including the icon on the server. In one or more embodiments, the icon is a digital picture or a graphical image indicative of a classification of the selected location.

As is apparent from the description above, some portions of the detailed descriptions herein are presented in terms of a software implemented process involving symbolic representations of operations on data bits within a memory of a mobile electronic device. These descriptions and representations are the means used by those in the art to most effectively convey the substance of their work to others skilled in the art. The process and operation require physical manipulations of physical quantities that will physically transform the particular machine or system on which the manipulations are performed or on which the results are stored. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Furthermore, the execution of the software's functionality transforms the computing apparatus on which it is performed. For example, acquisition of data will physically alter the content of the storage, as will subsequent processing of that data. The physical alteration is a “physical transformation” in that it changes the physical state of the storage for the computing apparatus.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

I claim:

1. A mobile location information system comprising:
a server;
a database operatively coupled to the server and containing information specific to a plurality of geographic locations; and
a mobile electronic device including a GPS component and a storage, and operating an application program installed on the storage of the mobile electronic device, the application program including program instructions to:
transmit a selected location to the server;
receive a map of the selected location from the server; and
receive information specific to one geographic location of the plurality of geographic locations from the database via the server, the one geographic location being identical to the selected location, and the information specific to the one geographic location including at least one of language spoken, currency used, government type, common spoken phrases, and cultural practices.

2. The mobile location information system of claim 1, wherein the selected location is determined by the GPS component.

3. The mobile location information system of claim 1, wherein:
the database further includes a plurality of user profiles; and
the application program further includes program instructions to receive a specific user profile from the database via the server based on authentication information provided to the application program.

4. The mobile location information system of claim 3, wherein the application program further includes program instructions to receive a plurality of user profiles from the database via the server based on authentication information provided to the application program.

5. The mobile location information system of claim 1, wherein:
the mobile electronic device further includes a display; and
the application program further includes program instructions to
display the map of the selected location on the display of the mobile electronic device, and
denote the map of the selected location with an icon.

6. The mobile location information system of claim 6, wherein the icon may be a thumbnail of a graphical image, and the selected location is determined by the GPS component.

7. The mobile location information system of claim 6, wherein the icon is color-coded, each color having a particular meaning associated therewith.

8. The mobile location information system of claim 1, wherein the selected location is based on input from a user, the input selected from a group consisting of a country, a zip code, a city, a state, and a point of interest.

9. A method for providing location information to a user of a mobile electronic device, comprising:
receiving via a server a selected location from the mobile electronic device;
generating a map of the selected location;
transmitting the map of the selected location from the server to the mobile electronic device;
searching one or more databases operatively coupled to the server and containing information specific to a plurality of geographic locations;
retrieving, from the one or more databases, information specific to one of the geographic locations matching the selected location, the information including at least one of language spoken, currency used, government type, common spoken phrases, and cultural practices; and
transmitting the information to the mobile electronic device.

10. The method of claim 9, wherein the selected location is determined by a GPS component of the mobile electronic device.

11. The method of claim 9, wherein the selected location is based on input from the user, the input selected from a group consisting of a country, a zip code, a city, a state, and a point of interest.

12. The method of claim 9, further comprising:
storing a user profile of the user on the server; and
providing access to the user profile to other users based on privacy settings selected by the user.

13. The method of claim 12, further comprising:
associating an icon with the selected location on the map; and
storing the map of the selected location including the icon on the server.

14. The method of claim 13, wherein the icon is a digital picture or a graphical image indicative of a classification of the selected location.

15. The method of claim 9, wherein the information specific to the geographic location matching the selected location includes one or more links configured to retrieve additional information specific to the geographic locations matching the selected location.

16. A mobile electronic device comprising:
a display;
a processor;
a bus system;
a storage that, in operation, communicates with the processor over the bus system; and
an application program residing on the storage that, when invoked by the processor over the bus system, includes program instructions to:
transmit a selected location to a server communicatively coupled to the mobile electronic device;
receive a map of the selected location from the server;
display the map of the selected location on the display; and
receive information specific to the selected location from one or more databases operatively coupled to the server, the information specific to the selected location including at least one of language spoken, currency used, government type, common spoken phrases, and cultural practices.

17. The mobile electronic device of claim 16, further comprising a GPS component, wherein the selected location is determined by the GPS component.

18. The mobile electronic device of claim 16, wherein the information specific to the selected location includes one or more links configured to retrieve additional information specific to the selected location.

19. The mobile electronic device of claim 16, wherein the selected location is based on input from a user, the input selected from a group consisting of a country, a zip code, a city, a state, and a point of interest.

20. The mobile electronic device of claim 16, further comprising a camera configured to capture digital images and store the digital images in the storage, and the application program further includes program instructions to:
upload one or more of the digital images to the server;
associate the uploaded digital images with the selected location; and
display thumbnail images of the uploaded digital images on the map of the selected location.
